(19) United States
(12) Patent Application Publication
(10) Pub. No.: US 2011/0289461 A1
(43) Pub. Date: Nov. 24, 2011

(54) Method and sytem for rendering computer interface cursors

(76) Inventor: Joshua Morgan Jancourtz, Mountainside, NJ (US)

(21) Appl. No.: 13/068,816

(22) Filed: May 19, 2011

Related U.S. Application Data
(60) Provisional application No. 61/346,884, filed on May 20, 2010.

(51) Int. Cl. G06F 3/048

(52) U.S. Cl. 715/856

(57) ABSTRACT

A processor-controlled system and method implementing a process for morphing a cursor tool between various states comprising the steps of displaying a cursor tool in a first state that includes a functionality and visual parameters with values, determining a second state of the cursor tool that includes a functionality and visual parameters with values, selecting an adjustment time period, changing the functionality of the cursor tool from the functionality of the first state to the functionality of the second state, and adjusting values of the visual parameters of the cursor tool in the first state, throughout the adjustment time period, until they are equivalent to the values of the visual parameters of the second state at the end of the adjustment time period and the cursor tool is displayed in the second state.

### CROSS-REFERENCE TO RELATED APPLICATION

This application claims the benefit of U.S. Provisional Patent Application Ser. No. U.S. 61/346,884, filed May 20, 2010 entitled Morphing Cursor for Computer User Interfaces, the entire disclosure of which is incorporated by reference herein.

### REFERENCE TO A COMPUTER PROGRAM LISTING APPENDIX SUBMITTED ON A COMPACT DISC

This application incorporates by reference a computer program listing appendix submitted on CD-ROM on the filing date of this document in duplicate as Copy 1 and Copy 2 and labeled in accordance with Rule 1.52(e)(6). The CD-ROM includes a single file containing computer code titled MorphCursor.txt which was created on May 18, 2011 and is 12,722 bytes in size.

### FIELD OF THE INVENTION

Generally speaking, the present invention relates to graphic user interfaces and associated systems and methods for displaying tool cursors within those interfaces. More specifically, the present invention is related to particular computerized and/or processor-controlled methods, devices, and systems for rendering user interface cursors that may transform smoothly into one another.

### BACKGROUND OF THE INVENTION

As graphical capabilities of computers evolved, consumer demand for rich-media application has grown. Presently, even average computer users are confronted with complex graphic user interfaces on a daily basis. To interact with such interfaces, users often use their computer mice to perform a myriad of tasks by manipulating the cursor tool displayed on the screen. Tasks such as zooming, scrolling, selecting, drawing, highlighting, dragging, etc. are typical operations effected via a cursor tool. Complex user interfaces often employ multiple cursor types to indicate different application states. For many applications, it is advantageous to have the mouse cursor correspond to the type of tool being utilized or the action being performed. For example, in response to a user moving a cursor over a button, a default arrow cursor may turn into a pointing finger icon to indicate that the button is clickable. An application, website, or operating system may offer various toolsets that render cursors with various functionality. For example, a selection tool in a graphics editing program may display a crosshairs cursor to indicate that the selection tool is enabled and that the user may now click and drag to make a selection. In another example, the mouse cursor may be represented as a magnifying glass to indicate that the user can zoom on an item on the screen. As used herein, the terms cursor and cursor tool are interchangeable.

Unfortunately, the common method for an application to transition the cursor tool from one cursor type to another is to make a sudden and jarring switch between one graphic icon and another. Accordingly, the present invention is directed towards systems and methods of rendering computer interface cursors in a way that is aesthetically pleasing and facilitates a more natural way of interacting with computer interfaces.

### BRIEF SUMMARY OF THE INVENTION

In one embodiment, there is disclosed a processor operated method for morphing a cursor tool between various states. The method includes the step of a processor-controlled device, such as for example, a computer, displaying a cursor tool in a first state that includes a functionality and visual parameters with values. The processor determines a second state of the cursor tool that includes a functionality and visual parameters with values. The processor, or a user, also selects an adjustment time period. The processor changes the functionality of the cursor tool from the functionality of the first state to the functionality of the second state. According to the method embodiment, the processor adjusts values of the visual parameters of the cursor tool in the first state, throughout the adjustment time period, until they are equivalent to the values of the visual parameters of the second state at the end of the adjustment time period and the cursor tool is displayed in the second state.

In another embodiment there is disclosed a system for displaying a morphing cursor tool comprising a computer system including at least one computer and a related database. Preferably, the computer system is communicatively connected via a network to one or more computers. The system is operative with a plurality of programming modules to display a cursor tool in a first state that includes a functionality and visual parameters with values. The system is further operable to determine a second state of the cursor tool that includes a functionality and visual parameters with values and selects an adjustment time period. The system is further enabled to change the functionality of the cursor tool from the functionality of the first state to the functionality of the second state; and adjust values of the visual parameters of the cursor tool in the first state, throughout the adjustment time period, until they are equivalent to the values of the visual parameters of the second state at the end of the adjustment time period and the cursor tool is displayed in the second state.

In a another embodiment, there is disclosed a computer readable medium containing a program which performs the functions of displaying a cursor tool in a first state that includes a functionality and visual parameters with values. The program on the computer readable medium further performs the functions of determining a second state of the cursor tool that includes a functionality and visual parameters with values, and selecting an adjustment time period. The program on the computer readable medium also performs the functions of changing the functionality of the cursor tool from the functionality of the first state to the functionality of the second state, and adjusting values of the visual parameters of the cursor tool in the first state, throughout the adjustment time period, until they are equivalent to the values of the visual parameters of the second state at the end of the adjustment time period and the cursor tool is displayed in the second state.

While in certain exemplary embodiments the above steps are performed in sequence, they may also be performed in different or alternative sequence of steps without departing from the broad inventive concept.

### BRIEF DESCRIPTION OF THE DRAWINGS

The foregoing summary, as well as the following detailed description of the preferred embodiments of the application, will be better understood when read in conjunction with the appended drawings. For the purposes of illustrating the user interface and associated method of use, there is shown, in the drawings, preferred embodiments. It should be understood, however, that the application is not limited to the precise arrangements and instrumentalities shown. In the drawings:

FIG. 1 illustrates the phases of an exemplary transition of a cursor between various states in an exemplary embodiment; and

FIG. 2 illustrates certain of the visual parameters of the cursor and their changes during the transition of FIG. 1.

### DETAILED DESCRIPTION OF EMBODIMENTS OF THE INVENTION

In an embodiment of the invention, a computer system is specifically programmed to provide, within a graphical user interface, at least one cursor that smoothly morphs between various states that are visually and functionally distinct.

The computer-based system preferably includes such art recognized components as are ordinarily found in computer systems, including but not limited to processors, RAM, ROM, clocks, hardware drivers, associated storage, and the like. The computer-based system may include servers and connections to networks such as the Internet, LAN, or other communication networks. The programming loaded on the computer system may be created in any programming language presently known or hereafter developed, such as for example, Adobe ActionScript, C, C++, JAVA, and C#. The non-limiting, exemplary code of an embodiment of the invention implemented in Adobe ActionScript 3.0 is included in the computer program listing appendix.

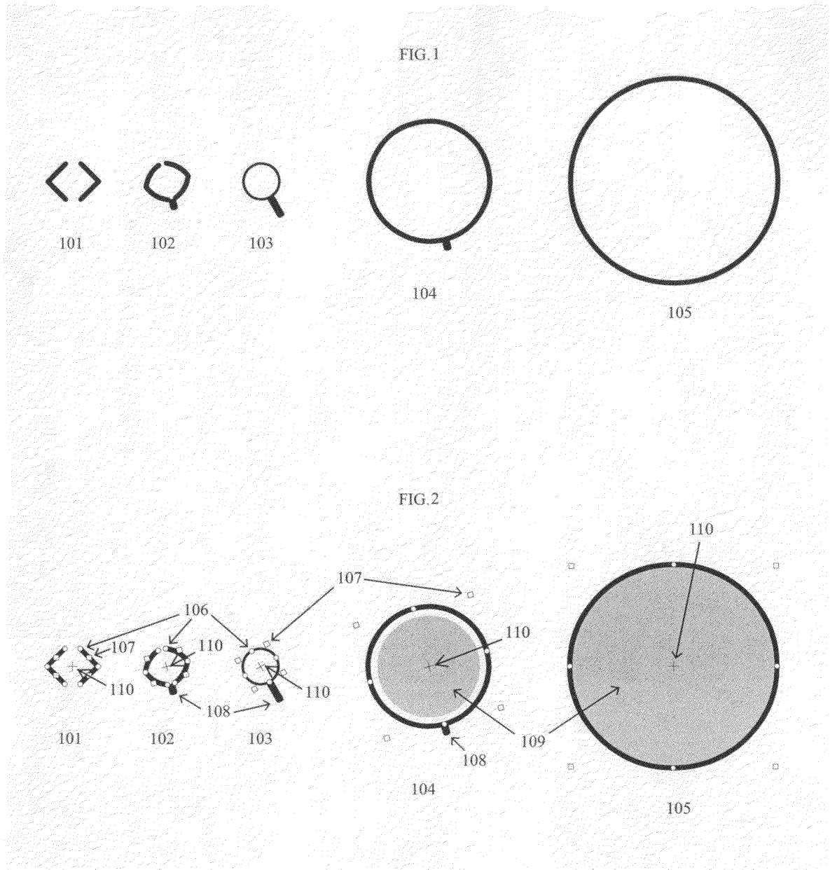

An exemplary embodiment of the invention will now be described with reference to the drawings. The invention is not limited to the exemplary embodiments shown and described. Referring to FIGS. 1-2, an exemplary embodiment provides a user with a cursor tool that can visually morph between various states allowing the cursor to look differently and perform various functions in those states. In the exemplary embodiment, the look of the various states of the cursor tool is preferably intended to evoke, in the mind of the user, the function that the cursor is capable of performing.

FIG. 1 shows various exemplary states of a cursor tool in use. According to an exemplary embodiment of the invention, the cursor tool is presented to a user in a graphical user interface and the cursor tool is capable of smoothly morphing between the various cursor states such as, for example, states 101, 103, and 105. In the shown embodiment, the arrows state 101 indicates to the user and that he/she may scroll left-to-right, closed magnifier state 103 indicates that a user may click to view an enlargement of an underlying image, and open magnifier state 105 may display enlargement of a section of an underlying image.

In use of the embodiment shown in FIGS. 1 and 2, the cursor tool may smoothly morph between states 101 and 103. During the exemplary morphing, the tool briefly assumes an intermediate state 102 before finally morphing into final or second state 103. At some stage during the morphing process the functionality of the cursor tool preferably changes from the functionality of the arrows state 101 into the functionality of closed magnifier state 103. Similarly, the cursor tool can smoothly morph between states 103 and 105 and briefly assume intermediate state 104 in the process. The cursor may also morph into open magnifier state 105 directly from intermediate state 102 if, for example, a user selects the open magnifier state 105, while the cursor is in the intermediate state 102 and undergoing the process of morphing from state 101 into state 103. The morphing may also work in reverse. It should be further noted that the morphing of the cursor tool can proceed in any order and between any number of states and the invention should not be limited to any particular morphing progression between the various states of the cursor tool. It should be further noted, that in some instances the cursor in multiple states may have the same functionality, no functionality, or a null functionality.

To enable the capabilities described above, in the exemplary embodiment of the invention, the various cursor states are defined with graphic imaging data that includes at least a set of visual parameters that are common to each cursor state. The term visual parameters, as used herein, refers to parameters that are capable of affecting how an image is rendered or displayed, and the parameters themselves may not always be seen, for example if they have zero values. These parameters may include drawing information such as, for example, line start, end points, curve points, line thicknesses, line colors, fill colors, transparency values, gradient values, dropshadow filters, or any other parameter that can be used by a computer program to graphically render a cursor.

Accordingly, to morph the cursor from one state or a first state to another, the values of the common parameters are adjusted over a time interval from those of one state to those of another state or second state. The adjustment of the values may be accomplished with any manner of easing, such as linear, quadratic, bounce, back, or Zeno's paradox. It should be noted that the time period for adjusting the values of the common parameters from a first state to a second state may be pre-set, set by a user, or calculated based on a formula, or based on any other criteria such as, for example, the speed of a user's movement of the cursor tool. It should also be noted, that in certain embodiments of the invention the values of the various parameters may not be numeric, and the displayed adjustment of those visual values may be performed in other appropriate ways, for example, through a fading effect or conversion to numerical values.

FIG. 2 highlights some common parameters shared among target cursor states 101, 103 and 105, and transition states 102 and 104, thus illustrating how the values of a set of common parameters may be altered to draw cursors of different states as well as transitions between these states. These exemplary parameters in common include rotation, line anchor points, line control points, handle length, and lens mask radius.

Cursor center 110 represents the center of the cursor with its crosshairs showing the rotation amount for the entire cursor. Beginning with arrows cursor state 101, the cursor has no rotation. Closed magnifier cursor state 103 does have some rotation, and transition state 102 therefore has rotation in between these two amounts. Similarly, transition state 104 has a rotation amount in between the rotation amounts of closed magnifier cursor state 103 and open magnifier state 105.

As further illustrated in FIG. 2, line anchor points 106 are represented by hollow circles and line control points 107 are represented by hollow squares. An anchor point 106 is an endpoint of a line segment and a control point 107 is a point that describes the curvature between two anchor points 106. In arrows cursor state 101, anchor point 106 appears at the end of a line segment while in closed magnifier cursor state 103 it appears within the curve of a circle. This change in appearance is due to the changing values of anchor points 106 and control points 107. For example, control point 107 creates a straight line segment when positioned between two anchor points 106 in arrows cursor 101, and it creates a circular curve when placed at a right angle to these anchor points 106 in closed magnifier cursor state 103.

Also in FIG. 2, cursor handle 108 appears at full size in closed magnifier 103. In this exemplary implementation, the cursor handle is drawn as a rounded rectangle starting at a distance from cursor center 110 plus the radius of the current cursor state. As a common parameter among the set of cursor states, this cursor handle element still exists in arrows cursor state 101 and open magnifier state 105, but it is not discernable because the scale of its length has been reduced to zero. Transition state 102 and transition state 104 show the cursor handle transitioning between a length of 0% and 100% of full size.

Similarly demonstrated in FIG. 2, lens mask 109 appears at full size in open magnifier state 105, represented by the shaded area where an image enlargement is revealed. As a common parameter among the set of cursor states, this lens mask element still exists in arrows cursor state 101 and in closed magnifier cursor state 103, but it is not discernable because the scale of its radius has been reduced to zero. Transition state 104 shows the lens mask area transitioning with a radius between 0% and 100% of full size.

Although not labeled in FIG. 2, other illustrated parameters are line thickness and cursor radius. For example, the line thickness in the circular portion of closed magnifier cursor state 103 has a smaller value than the line thickness in the arrows cursor state 101 and the open magnifier state 105. The cursor radius represents the distance of the left and right anchor points to the cursor center and has a greater value in open magnifier state 105 than in arrows cursor state 101 and closed magnifier cursor state 103. Values for line thickness and radius parameters are preferably interpolated while transitioning between states.

An embodiment of a graphical user interface where use of the morphing cursor may be advantageous is a graphical user interface used to view multi-angle images, for example a 360 degree view of an object, such as an article that a consumer may want to purchase. In use together with such a graphical user interface, cursor in arrows cursor state 101 can be used to rotate the object on the screen and a cursor in closed magnifier cursor state 103 may be used to zoom in on the object. Open magnifier state 105 may be used to inspect areas of the displayed object.

The cursor states and common parameters described above are just one implementation of a morphable cursor tool set. Many other parameters and implementations are possible. Moreover, in some implementations all of the parameters are shared between the cursors, while in others, only a subset.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

I claim:

1. A processor operated method for morphing a cursor tool between various states comprising the steps of:
displaying a cursor tool in a first state that includes a functionality and visual parameters with values;
determining a second state of the cursor tool that includes a functionality and visual parameters with values;
selecting an adjustment time period;
changing the functionality of the cursor tool from the functionality of the first state to the functionality of the second state; and
adjusting values of the visual parameters of the cursor tool in the first state, throughout the adjustment time period, until they are equivalent to the values of the visual parameters of the second state at the end of the adjustment time period and the cursor tool is displayed in the second state.

2. The method of claim 1, wherein the visual parameters of the first state are the same as visual parameters of the second state.

3. The method of claim 1, wherein the visual parameters of both the first state and the second state include parameters selected from the group consisting of line start, end point, curve point, line thickness, line color, line curvature, fill color, transparency value, gradient value, and dropshadow filter.

4. The method of claim 1, wherein the values of visual parameters are numeric and the step of adjusting values is performed continuously throughout the adjustment time period.

5. The method of claim 1, further comprising the step of determining the adjustment period based upon a user's interaction.

6. The method of claim 5, wherein the user's interaction is a rate of movement of the cursor tool.

7. The method of claim 1, further comprising the step of determining the adjustment period based upon the difference between the values of the visual parameters of the first state and the values of the visual parameters of the second state.

8. The method of claim 1, wherein the adjusting of the visual parameters is performed using a process selected from the group consisting of linear, quadratic, bounce, back, and Zeno's paradox.

9. A system for displaying a morphing cursor tool comprising:
a computer system including at least one computer and a related database, the computer system operative with a plurality of programming modules to:
display a cursor tool in a first state that includes a functionality and visual parameters with values;
determine a second state of the cursor tool that includes a functionality and visual parameters with values;
select an adjustment time period;
change the functionality of the cursor tool from the functionality of the first state to the functionality of the second state; and
adjust values of the visual parameters of the cursor tool in the first state, throughout the adjustment time period, until they are equivalent to the values of the visual parameters of the second state at the end of the adjustment time period and the cursor tool is displayed in the second state.

10. The system of claim 9, wherein the visual parameters of the first state are the same as visual parameters of the second state.

11. The system of claim 9, wherein the visual parameters of both the first state and the second state include parameters selected from the group consisting of line start, end point, curve point, line thickness, line color, line curvature, fill color, transparency value, gradient value, and dropshadow filter.

12. The system of claim 9, wherein the system is further connected via a network to one or more computers and wherein the values of visual parameters are numeric.

13. The system of claim 9, further operative to determine the adjustment period based upon a user's interaction.

14. The system of claim 13, wherein the user's interaction is a rate of movement of the cursor tool.

15. The system of claim 9, further operative to determine the adjustment period based upon the difference between the values of the visual parameters of the first state and the values of the visual parameters of the second state.

16. The system of claim 9, wherein adjustment of the visual parameters is configured to be performed using a process selected from the group consisting of linear, quadratic, bounce, back, or Zeno's paradox.

17. A computer readable medium containing a program which performs the functions of:
displaying a cursor tool in a first state that includes a functionality and visual parameters with values;
determining a second state of the cursor tool that includes a functionality and visual parameters with values;
selecting an adjustment time period;
changing the functionality of the cursor tool from the functionality of the first state to the functionality of the second state; and
adjusting values of the visual parameters of the cursor tool in the first state, throughout the adjustment time period, until they are equivalent to the values of the visual parameters of the second state at the end of the adjustment time period and the cursor tool is displayed in the second state.

18. The computer readable medium of claim 17, wherein the function of determining the second state is configured to be performed based upon a user's input

19. The computer readable medium of claim 17, wherein the visual parameters of both the first state and the second state include parameters selected from the group consisting of line start, end point, curve point, line thickness, line color, line curvature, fill color, transparency value, gradient value, and dropshadow filter.

20. The computer readable medium of claim 19, further including the function of determining the adjustment period based upon the difference between the values of the visual parameters of the first state and the values of the visual parameters of the second state.
